(19) United States
(12) Patent Application Publication
(10) Pub. No.: US 2003/0078069 A1
(43) Pub. Date: Apr. 24, 2003

(54) Portable communication device with split user inputs

(76) Inventor: Phillip Lindeman, St. Joseph, MI (US)

Correspondence Address: MOTOROLA INC, 600 NORTH US HIGHWAY 45, LIBERTYVILLE, IL, 60048-5343, US

(21) Appl. No.: 09/999,688

(22) Filed: Oct. 24, 2001

(51) Int. Cl. H04M 1/00

(52) U.S. Cl. 455/550; 455/566

(57) ABSTRACT

Portable communication devices integrate functions such as radiotelephone capabilities with messaging or personal digital assistant (PDA) functions. A foldable portable communication device to accommodate the space limitations while providing the necessary tool to operate the provided functions comprises of a first housing portion and a second housing portion each having a user inputs, such as a QWERTY keyboard. When the device is open, the portable communication device operates in one mode, such as messaging mode and utilizes both user input devices on each housing. A display for displaying text is located between the first housing portion and the second housing portion. In the closed position, the first housing and second housing are coupled together and user inputs are used for a separate mode in the closed position, such as radiotelephone mode.

### FIELD OF THE INVENTION

The present invention relates generally to a portable communication device and more specifically to a multi-functioning radiotelephone device, for example integrated with messaging or PDA capabilities.

### BACKGROUND OF THE INVENTION

Portable communication devices are becoming more and more popular as size, weight and functionality improve. Portable communication devices traditionally include such devices as radiotelephones, two-way radios, paging mechanisms, messaging devices, and personal data assistants. Two or more devices are often combined into one portable communication device.

Two or more devices are often combined into one portable communication device increasing functionality. As portable communication devices combine functions, there is a need to combine features to operate the functions separately without increasing the overall size of the portable communication device. The reduction in size of portable communication devices leads to space limitations for user input devices.

User input devices need to be integrated in order to facilitate a portable communication device's multiple functions, for example, a QWERTY keyboard for messaging functions and a standard keypad for radiotelephone functions. QWERTY keyboards include the 26 letters of the alphabet along with punctuation characters such as ; &, and ?. Standard keypads include the numbers 0-9 and the function keys SND, END, CLR. The key selected, by pushing the button corresponding to the input desired, inputs the resultant data into the portable communication device.

Accordingly, what is needed is a portable communication device with a split user input device, such as a QWERTY keyboard, so the entire keyboard is accessible in an open position to perform one function and can be folded into a closed position in order to reduce the size and perform a separate, second function.

### BRIEF DESCRIPTION OF THE DRAWINGS

The features of the present invention which are believed to be novel are set forth with particularity in the appended claims. The invention, together with further objects and advantages thereof, may best be understood by making reference to the following description, taken in conjunction with the accompanying drawings, in the several figures of which like reference numerals identify like elements, and wherein:

FIG. 1 is a perspective view of a portable communication device in the open position.

FIG. 2 is a perspective view of a portable communication device in the closed position.

FIG. 3 is a method for closing the portable communication device.

FIG. 4 is an alternative method for closing the portable communication device.

FIG. 5 is an electrical block diagram of the portable communication device.

FIG. 6 is a perspective view of a user operating a portable communication device in the open position.

Although the present invention is illustrated in these figures, the drawings and following description are not be interpreted as limiting the innovation. They are used to describe this invention for the purpose of fully understanding. In certain cases, well-known or conventional details are not included.

### DETAILED DESCRIPTION OF THE INVENTION

The present invention is a portable communication device such as a radiotelephone integrated with a separate function such as messing or PDA. When the portable communication device is in the open position, a first function is operable. The input keys are split onto two separate housings to increase the number of input keys, for example a QWERTY keyboard, where one portion is on the first housing and another portion is on the second housing. A display is located between the housings in the open position to communicate and display information such as messaging or PDA. The text is displayed in a landscape position while the portable communication device is in the open position The housings can be folded together to accommodate space limitations and size reduction. When the portable communication device is in the closed position, a second function is operable. The input keys are on a housing that is accessible when the portable communication device is in the closed position. The display is located on one end of both housings in the closed position and displays text in the portrait position.

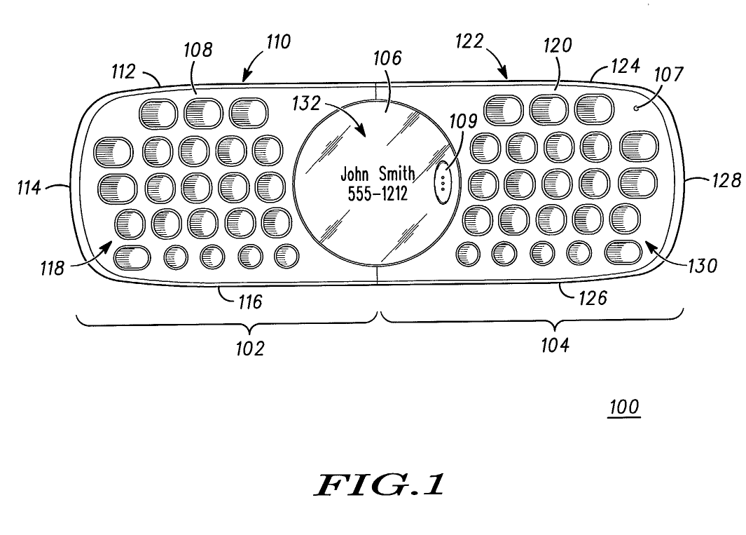

FIG. 1 is a perspective view of a portable communication device in the open position. As shown in FIG. 1, a portable communication device 100 according to the present invention includes a first housing portion 102, a second housing portion 104, and a display 106. Display 106 provides information to the user, such as visual feedback of entered characters. The portable communication device 100 includes a microphone 107 and a speaker 109. Speaker 109 is behind display 106. The sound is acoustically channeled through the holes in display 106.

An antenna supports wireless communication with a base station. The antenna can be internal or external. External antennas are located outside of the radiotelephone housing. They can be fixed or can be retracted from a first position to a second position. Planar Inverted F-Antennas (PIFA) are internal antennas that eliminate the need for external antennas. Either external or internal antennas can be either single band or dual band.

The first housing portion 102 and second housing portion 104 pivot in order to provide an open and closed position. In the open position, the display 106 is located between the first housing portion 102 and the second housing portion 104. Although shown as a circular shaped display, those skilled in the art will recognize that any shape display could be used, for example a rectangular shape. In the open position, the display 106 presents information such as text in the landscape position 132.

When the portable communication device 100 is in the open position, a first function is operable, such as messaging or PDA. In FIG. 1, the portable communication device 100 is in the open position. It is anticipated that other equally sufficient embodiments of the present invention may include other functions in the open position.

The first housing portion 102 has a first front side 108, first backside 110, first edge 112, second edge 116, and third edge 114. The second housing portion 104 has a second front side 120, second backside 122, fourth edge 124, fifth edge 126, and sixth edge 128. In the open position, the first edge 112 is collinear with the fourth edge 124 and the second edge 116 is collinear with the fifth edge 126.

The first front side 108 has a first input device 118, or keypad, and the second front side 120 has a second input device 130, or keypad. For example, the first front side 108 is a first portion of a QWERTY keyboard and the second front side 120 is a second portion of a QWERTY keyboard so that in the open position, a full QWERTY keyboard is accessible on the portable communication device 100. A QWERTY keyboard comprises of the alphabetical letters A-Z, numerals 0-9, and various symbol keys such as #, *, “, and ?. Input keys are selected by pushing the button corresponding to the letter or number desired. The key selected inputs the resultant data into the portable communication device 100.

It is known to one of ordinary skill in the art that the first input device 118 and the second input device 130 could be a scratch pad or touch screen. Scratch pads can be used to input data into a portable communication device by writing the corresponding character with a marker, pointer, stylus, finger or hard object. Touch screens display images that can also be selected by a marker, pointer, stylus, finger or hard object, which results in the corresponding image input as data.

When the portable communication device 100 pivots into the closed position, a second function is operable, such as radiotelephone mode. The radiotelephone mode is operable in the closed position of the portable communication device 100. It is anticipated that other equally sufficient embodiments of the present invention may include other functions in the closed position.

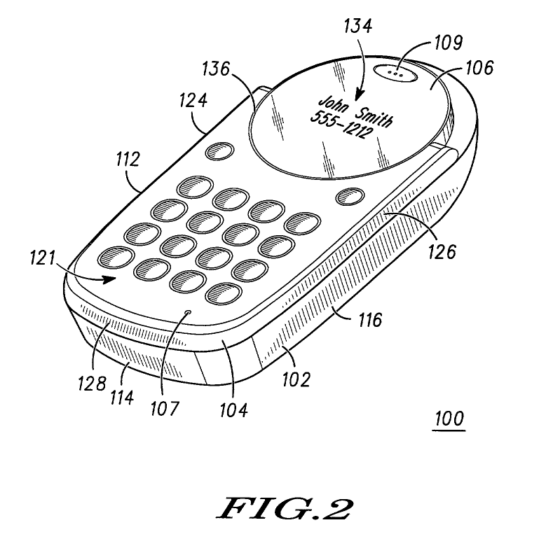

FIG. 2 is a perspective view of a portable communication device in the closed position. As shown in FIG. 2, when the portable communication device 100 is pivotally flipped into the closed position, a numeric keypad 121 is visible to use in conjunction with the radiotelephone mode. The numeric keypad 121 can be on the first housing portion 102 or the second housing portion 104, which is described in further detail below.

In the closed position, the second housing portion 104 substantially covers the first housing portion 102, such that the first edge 112 and fifth edge 124 are adjacent, the second edge 116 and fourth edge 126 are adjacent, and the third edge 114 and sixth edge 128 are adjacent.

When the portable communication device is in the closed position, the display 106 is located substantially above the first housing portion 102 and the second housing portion 104. In the closed position, the display 106 presents information such as text in the landscape position 134. Display 106 includes speaker 109. Speaker 109 is behind display 106. The sound is acoustically channeled through the holes located in display 106. Speakers include dynamic speakers that increase the number of tones that can be acoustically channeled. The second housing portion 104 includes a microphone 107. Microphones include high sensitivity microphones that minimize distortion.

Microphone 107 and speaker 109 are located on portable communication device 100 so that they are utilized in the closed position. Portable communication device 100 operates as a radiotelephone in the closed position. The user holds portable communication device 100 so that speaker 100 is located at the top while microphone 107 is located at the bottom.

The second housing portion 104 also has a cut out opening 136 at the end opposite the sixth edge 128. This cut out opening 136 accommodates the shape of the display 106 while coupling the first housing portion 102 to the second housing portion 104 into the closed position. Therefore, the display 106 is visible to the user in both the opened and closed positions.

The cut out opening 136 is circular since the display 106 circular. Although shown as a circular shaped display, those skilled in the art will recognize that any shape display could be used, for example a rectangular shape.

The display 106 is integrated into the first housing portion 102. It is obvious to one skilled in the art that the display 106 can be integrated with the second housing portion 104.

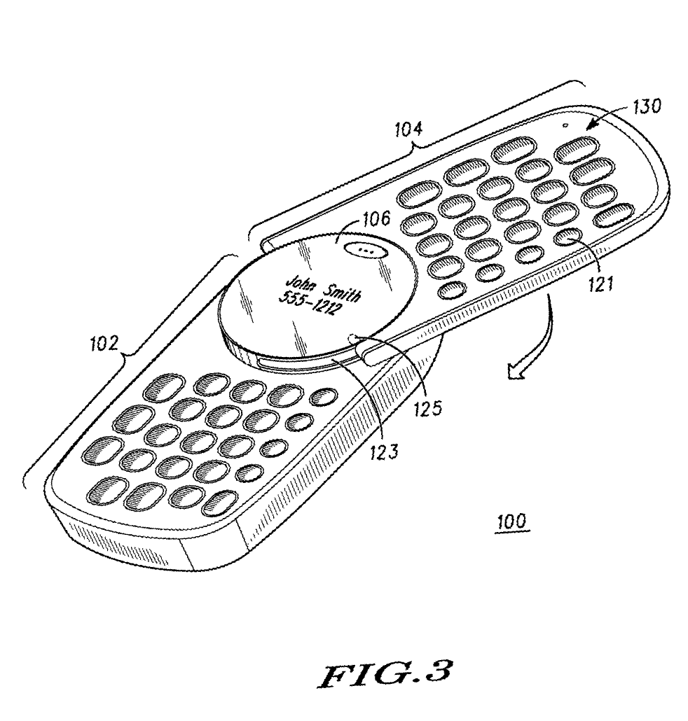

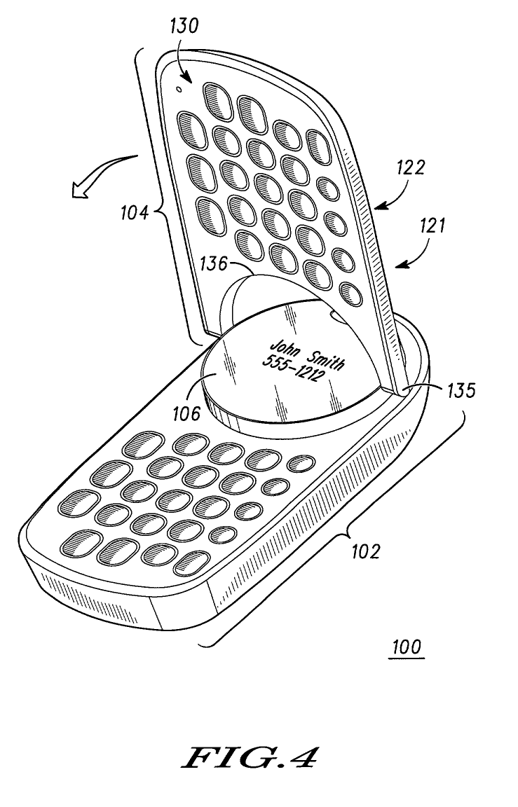

FIG. 3 is a method for closing the portable communication device. FIG. 4 is an alternative method for closing the portable communication device. As shown in FIG. 3 and FIG. 4, the first housing portion 102 and second housing portion 104 are moveable coupled to provide a closed position.

A pivotal configuration as shown in FIG. 3, the second housing portion 104 movable couples to the first housing portion 102 by pivotally rotating around the display 106 to obtain the closed position from the open position. The first housing portion 104 and the second housing portion 102 pivotally rotate in the same plane to achieve the closed position. It is obvious to one of ordinary skill in the art that the second housing portion 104 could moveable couple to the first housing portion 102.

In order to rotate, the second housing portion 104 has a tongue 125 and the first housing portion 102 has a groove 123. The tongue 125 is a protrusion on the cut out opening 136 of the second housing portion 104. The groove 123 is a recess along the display 106 with a locking feature such as a notch at the ends of the groove 123. The tongue 125 slides in the groove 123 along the display 106. The second housing portion 104 rotates around the display 106. Once the tongue 125 reaches a notch at the end of the groove 123, the tongue 125 is locked into place to align the second housing portion 104 with the first housing portion 102. One of ordinary skill in the art would know of other means for pivot rotation, for example, a swivel mechanism.

In the closed position, the second input device 130 of the second housing portion 104 is visible and lies below the display 106. The second input device 130 includes input keys for use in two different modes. Input keys are used to operate the portable communication device 100 in the open position, such as messing or PDA. The input keys are also used to operate the portable communication device 100 in the closed position, for example radiotelephone mode. For example, the second input device 130 includes a numeric keypad 121 and a first portion of a QWERTY keyboard. Therefore, the numeric keypad 121 is accessible for the radiotelephone mode in the closed position and the QWERTY keyboard is accessible for the messaging or PDA mode in the open position. The numeric keypad 121 contains individual keys numbered 0-9 along with function keys such as send (SND), end (END), recall (RCL), and store (STO) for radiotelephone mode operation.

A clamshell configuration as shown in FIG. 4, the second housing portion 104 movable couples to the first housing portion 102 by pivotally flipping over the display 106 to obtain the closed position from the open position. It is obvious to one of ordinary skill in the art that the first housing portion 102 could pivotally flip to the second housing portion 104.

In order to rotate, a hinge 135 couples the first housing portion 102 to the second housing portion 104 that extends across the entire portable communication device 100. The second housing portion 104 rotates over the display 106. A follower is secured in the first housing portion 102 and a cam is secured in the second housing portion 104. The cam rotates with the second housing portion 104 as it is moved between the open and closed position. One of ordinary skill in the art would know of other means for pivot rotation, for example a pair of hinges.

In the closed position, the second backside 122 of the second housing portion 104 is visible and lies below the display 106. A numeric keypad 121 and microphone 107 to use in conjunction with the radiotelephone mode is on the second backside 122 of the second housing portion 104 integrated opposite the second input device 130. Therefore, in the closed position a numeric keypad 121 is accessible in the radiotelephone mode. The numeric keypad 121 contains individual keys numbered 0-9 along with function keys such as send (SND), end (END), recall (RCL), and store (STO) for radiotelephone mode operation.

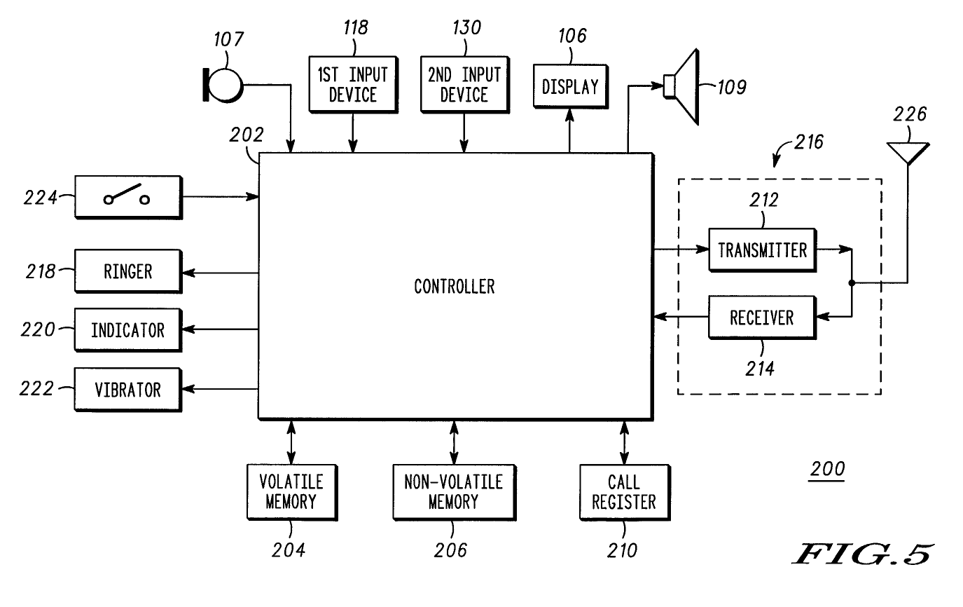

FIG. 5 is an electrical block diagram illustrating a circuit 200 positioned within in portable communication device 100. Circuit 200 includes a controller 202, which may be a microprocessor, a micro-controller, a digital signal processor (DSP), a programmable logic unit, or a combination of such components. Controller 202 can include volatile memory 204, which may for example be random access memory (RAM), and non-volatile memory 206, which may be implemented using Electronically Erasable Programmable Read Only Memory (EEPROM), Flash Read Only Memory (ROM), Electronically Programmable Read Only Memory (EPROM), or the like. Controller 202, or Central Processing Unit (CPU), selectively controls the operation of portable communication device 100 including radiotelephone mode and messaging or PDA mode.

Controller 202 is connected to the first input device 118 and the second input device 130 to receive user inputs. Controller 202 is also connected to speaker 109 that outputs audio and a microphone 107 that inputs audio. Controller 202 drives display 106 that is used to show information to the user.

The display 106 shows text in the portrait position 134 when the portable communication device 100 is in the radiotelephone mode, or closed position. The display 106 shows text in the landscape position 132 when the portable communication device 100 is in the messaging or PDA mode, or open position. A switch 224 within the portable communication device 100 is activated when the second housing portion 104 is coupled with the first housing portion 102. When the switch 224 is activated, the controller 202 communicates to the display 106 so the text is displayed in the portrait position 134. When the portable communication device 100 is in the open position, the switch 224 is not activated and the controller 202 communicates to the display 106 so the text is displayed in the landscape position 132.

Antenna 226, a radio frequency (RF) input, is connected between the transmitter 212 and receiver 214 of the transceiver 216. The transmitter 212 transmits data from the controller 202 and the receiver 214 receives data and relays the information to the controller 202. Ringer 218, indicator 220, and vibrator 222 are alerts for the user and are coupled to controller 202.

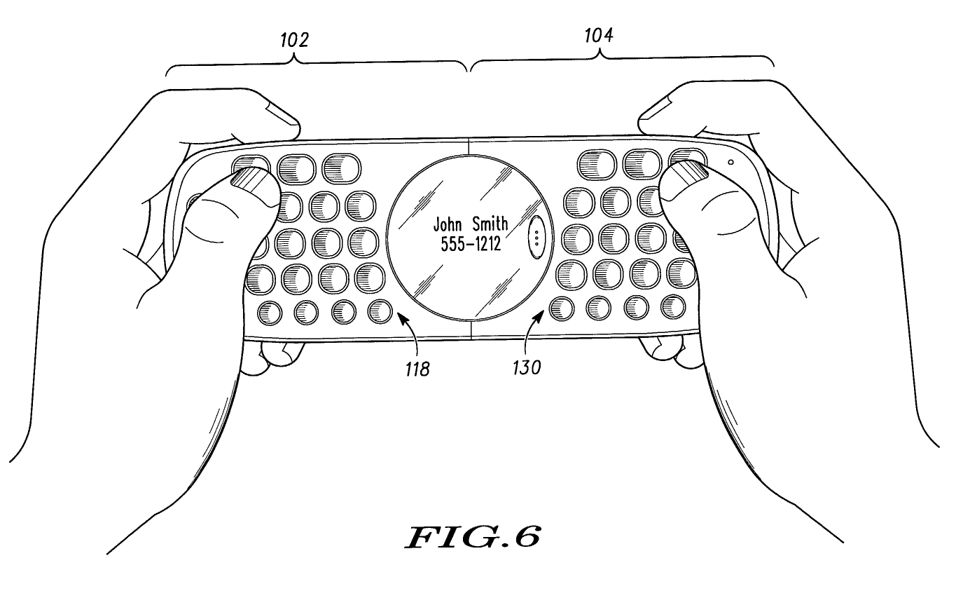

FIG. 6 is a perspective view of a user operating a portable communication device 100 in the open position. When the portable communication device is in the open position, the user supports the first housing portion 102 and uses the first input device 118 with the left hand. The user supports the second housing portion 104 and uses the second input device 130 with the right hand. Therefore, the user can access a full QWERTY keyboard if the first input device 118 is a first portion of a QWERTY keyboard and a second input device 130 is a second portion of a QWERTY keyboard.

While this invention has been described in connection with the preferred embodiment, it is obvious that modifications and changes may be made without departing from the scope of the invention.

We claim:

1. A portable communication device comprising:
a first housing portion including a first keypad;
a second housing portion moveably coupled to the first housing portion,
the second housing portion including a second keypad,
the first and second housing portions moveable between first and second positions; and
a display disposed between the first and second housing portions when the first and second housing portions are in the first position,
the display disposed substantially toward one end of the first and second housing portions when the first and second housing portions are in the second position.

2. The portable communication device of claim 1, the first and second housing portions constituting a clamshell housing, the clamshell housing open when the first and second housing portions are in the first position, the clamshell housing closed when the first and second housing portions are in the second position.

3. The portable communication device of claim 2, the first and second keypads on a common side of the first and second housing portions with the display when the clamshell housing is in the first position, the first keypad on one side of the display, the second keypad on another side of the display.

4. The portable communication device of claim 3, a third keypad on an outside of the first housing portion opposite the side thereof on which the first keypad is disposed.

5. The portable communication device in claim 3, the first and second keypad are a first and second portion of a QWERTY keyboard.

6. The portable communication device of claim 4, the third keypad is a numeric keypad.

7. The portable communication device of claim 2, the first keypad is on an inside of the first housing portion when the clamshell housing is in the second position, and the second keypad is on an outside of the second housing portion when the clamshell housing is in the first position.

8. The portable communication device of claim 7, the first keypad is a QWERTY keyboard.

9. The portable communication device of claim 7, the second is a numeric keypad.

10. The portable communication device of claim 1, the first and second housing portions rotatable relative to a plane, the first and second housing portions substantially non-overlapping in the first position, the first and second housing portions substantially overlapping in the second position.

11. The portable communication device of claim 10, the first and second keypads on a common side of the first and second housing portions with the display when the clamshell housing is in the first position, the first keypad on one side of the display, the second keypad on another side of the display.

12. The portable communication device in claim 11, the first and second keypad are a first and second portion of a QWERTY keyboard.

13. The portable communication device of claim 11, the third keypad is a numeric keypad.

14. The portable communication device of claim 1, text of the display in a portrait position when the portable communication device is in the second position.

15. The portable communication device of claim 1, text of the display in a landscape position when the portable communication device is in the first position.

16. The portable communication device of claim 1, the portable communication device is a first device in the first position.

17. The portable communication device of claim 1, the portable communication device is a second device in the second position.

18. The portable communication device in claim 16, the first device is a messaging device.

19. The portable communication device in claim 16, the first device is a personal data assistant device.

20. The portable communication device in claim 17, the second device is a radiotelephone device.

21. A portable communication device comprising:
a first housing portion,
the first housing portion including a keypad of a first portion of a QWERTY keyboard;
a second housing portion moveably coupled to the first housing portion,
the second housing portion including a keypad of a second portion of a QWERTY keyboard;
the portable communication device a first device in the first position and the portable communication device a second device in the second position;
a display disposed between the first and second housing portions in the first position,
the display disposed on one end of the first and second housing portions in the second position; and
a numeric keypad disposed substantially toward one end of the first and second housing portions in the second position.

22. The portable communication device of claim 21, text of the display in a portrait position when the portable communication device is in the second position.

23. The portable communication device of claim 21, text of the display in a landscape position when the portable communication device is in the first position.

24. The portable communication device in claim 21, the first device is a messaging device.

25. The portable communication device in claim 21, the first device is personal data assistant device.

26. The portable communication device in claim 21, the second device is a radiotelephone device.

27. A portable communication device comprising:
a first housing portion,
the first housing portion including a keypad of a first portion of a QWERTY keyboard;
a second housing portion moveably coupled to the first housing portion,
the second housing portion including a keypad of a second portion of a QWERTY keyboard;
the portable communication device a messaging device in the first position and the portable communication device a radiotelephone device in the second position;
a display disposed between the first and second housing portions in the first position;
the display disposed on one end of the first and second housing portions in the second position,
text of the display in a landscape position when the portable communication device is in the messaging mode and text of the display in a portrait position when the portable communication device is in the radiotelephone mode; and
a numeric keypad disposed on a one of the first and second housing portions opposite the end of the display in the second position.
